(19) United States
(12) Patent Application Publication
(10) Pub. No.: US 2015/0103546 A1
(43) Pub. Date: Apr. 16, 2015

(54) HEADLAMP, MOTOR VEHICLE WITH A HEADLAMP AND METHOD FOR OPERATING A HEADLAMP

(71) Applicant: GM GLOBAL TECHNOLOGY OPERATIONS LLC, Detroit, MI (US)

(72) Inventors: Frank Langkabel, Ruesselsheim (DE); Ingolf Schneider, Ruesselsheim (DE)

(21) Appl. No.: 14/500,663

(22) Filed: Sep. 29, 2014

(30) Foreign Application Priority Data
Sep. 28, 2013 (DE) 102013016277.7

(51) Int. Cl. F21S 8/10

(52) U.S. Cl. CPC F21S 48/1225; F21S 48/1145; F21S 48/1736
USPC 362/510

(57) ABSTRACT

A headlamp for a vehicle, particularly a motor vehicle, is disclosed which includes a laser and a converter having a first conversion unit and a second conversion unit. The first conversion unit emits light of a first color temperature after its excitation by means of the laser. The second conversion unit emits light of a second color temperature after its excitation by means of the laser.

### CROSS REFERENCE TO RELATED APPLICATION

This application claims priority to German Patent Application No. 102013016277.7 filed Sep. 28, 2013, which is incorporated herein by reference in its entirety.

### TECHNICAL FIELD

The technical field pertains to a headlamp, a motor vehicle with a headlamp and a method for operating a headlamp.

### BACKGROUND

Different approaches for automotive front lighting are known. Most headlamps are fitted with a certain type of bulb such as, for example, halogen bulbs or xenon bulbs. Depending on the position of the drum switch, these bulbs can be used for the low beam, as well as the high beam. The high beam and the low beam therefore have the same relative spectral energy distribution in the region around the optical axis of the headlamps in the own traffic lane, as well as on both lateral edge regions of the traffic lane. This also applies to pedestrian zones in the city or the regions adjacent to a country road or highway. A city light distribution can be generated with a rotation of the drum switch or a turning light or cornering light can be produced with a pivoting motion of the headlamps.

The introduction of LED technology now makes it possible to purposefully control the light distribution by correspondingly activating the LED assemblies with their LEDs and optical systems and to purposefully adapt the light distribution for the low beam, the turning light or cornering light, as well as the high beam. In this case, the low beam and the high beam may either be realized in the form of separate assemblies or in the form of a common assembly.

The pertinent research and development recently began to focus on another efficient and energy-saving approach in the form of headlamps with a laser as light source. EP 2 618 044 A2 discloses a vehicle headlamp with a light-emitting area that illuminates under excitation by a laser element. The energy distribution of the exciting light incident on the light-emitting area is cylindrical in this case.

In all instances, the entire area to be illuminated by the vehicle headlamps is always illuminated with light of an identical and constant spectrum. This light spectrum depends on the lamps used and represents a compromise between different requirements with respect to human night vision.

Investigations have shown that the brightness sensitivity to longer-wavelength radiation decreases and the sensitivity to shorter-wavelength radiation increases in the mesopic state of the eye. This phenomenon is also known as Purkinje effect. Consequently, a subjectively uniform illumination by a headlamp with light of a constant light spectrum therefore requires an increased light intensity in the edge regions.

### SUMMARY

The present disclosure provides a headlamp and a method for operating a laser-based headlamp, by means of which an improved illumination of the area in front of a vehicle can be achieved. In this respect, the roadway in front of the vehicle is illuminated in such a way that the vehicle can be driven in a manner that reduces fatigue and the changed visual behavior of the human eye in darkness is simultaneously taken into consideration.

The present disclosure accordingly provides a headlamp for a vehicle, particularly a motor vehicle, with a laser and with a converter that includes a first conversion unit and a second conversion unit. The first conversion unit emits light of a first color temperature after its excitation by means of the laser. The second conversion unit emits light of a second color temperature after its excitation by means of the laser.

The present disclosure also provides a method for operating a headlamp for a vehicle including providing a laser and a converter with a first conversion unit and a second conversion unit. The first conversion unit emits light of a first color temperature after its excitation by means of the laser. The second conversion unit emits light of a second color temperature after its excitation by means of the laser. The first conversion unit and the first conversion unit are excited by means of the laser.

The present disclosure further provides a vehicle, particularly a motor vehicle, with a headlamp as described above.

One aspect of the present disclosure is based on the realization that the brightness sensitivity of the human eye to long-wavelength light is reduced and the sensitivity to short-wavelength radiation is increased in dark conditions in the mesopic state (night vision). On the other hand, a light spectrum that is based on daylight reduces vision fatigue such that there is a need to illuminate the region to be illuminated by the headlamp with light of different color temperatures.

In order to take this realization into account, one aspect of the present disclosure makes it possible to illuminate the central roadway region in front of the vehicle with a first color temperature such that the vehicle can be driven in a manner that reduces vision fatigue over a prolonged period of time. Furthermore, edge regions outside the central roadway region are illuminated with a different light spectrum. This makes it possible to respectively use different adapted light spectrums for the central region and the edge regions. These different light spectrums take into account the different light sensation of the human eye for the respective regions.

According to one aspect of the present disclosure, a headlamp for a vehicle that includes a light source in the form of a laser for generating the required light is proposed. Such a laser typically emits monochromatic coherent light. Consequently, this light only has radiation with a single predetermined wavelength. This light may lie in the wavelength range that is visible to the human eye. However, light outside the visible wavelength range would also be conceivable. For example, a laser that emits light of particularly high energy in the ultraviolet wavelength range may also be used.

The headlamp furthermore includes a converter that converts the monochromatic light emitted by the laser into visible light of a desired color temperature. For this purpose, the converter includes at least two conversion units that are respectively excited by the light emitted by the laser and as a result emit light of a predetermined color temperature. In this case, the color temperature of the light emitted by the respective conversion units is adapted to the desired color temperatures of the regions to be illuminated by the headlamp. Consequently, several regions within the illumination area of the headlamp can be illuminated with different color temperatures with a single light source in the form of a laser. Due to the plurality of conversion units in the converter, it is not necessary to provide several different light sources. In this way, a cost-effective and improved adaptation of the illumination area of a headlamp can be achieved.

According to another aspect of the present disclosure, a method suitable for operating a headlamp is provided which preferably emits monochromatic light with a single wavelength as already described above. The light may lie in the wavelength range that is visible to the human eye, as well as in the invisible wavelength range. Furthermore, a converter having at least two conversion units is provided. After excitation by means of the laser, the first conversion unit emits light of a first color temperature and an additional conversion unit emits light of a second color temperature after its excitation by means of the laser. After excitation of the conversion units of the converter with the monochromatic light of the laser, light of different color temperatures therefore is respectively emitted by the two conversion units. This makes it possible to illuminate the illumination area of the headlamp with different color temperatures.

According to another aspect of the present disclosure, a vehicle, particularly a motor vehicle such as a passenger car, is furthermore proposed. In this case, the vehicle includes a preferred headlamp.

According to yet another aspect of the present disclosure, a computer program product with a computer program is proposed, wherein said computer program contains instructions that prompt a program-controlled device to carry out the method herein described.

One aspect of the present disclosure makes it possible to divide the area illuminated by the laser headlamp into at least two sections. In this case, the individual sections can be illuminated with different light spectrums. Consequently, an optimized light spectrum that is adapted to the special requirements of the respective region can be chosen for each individual section. The optimized illumination can also be achieved with a relatively low light intensity in the respective sections. An efficient adaptation of the light spectrums for each section can be achieved in this case due to a phosphor optimization of the individual conversion units that make available the light for the respective sections.

In one embodiment, the laser includes a laser diode. Such lasers that are based on semiconductor diodes make it possible to generate laser radiation in a particularly efficient and cost-effective fashion. Laser diodes that emit blue light are particularly advantageous in this respect. However, the excitation of the preferred converter may also be realized with a laser that is excited in a different way.

In one embodiment, the first color temperature and the second color temperature differ. Due to the utilization of different color temperatures in the individual conversion units, it is possible to illuminate different regions of the illumination area of a preferred headlamp with correspondingly different color temperatures. Consequently, individual regions in the illumination area of the headlamp can be adapted to the specific visual properties of the human eye.

In one embodiment, the first conversion unit and/or the second conversion unit may include a phosphor converter. A conversion of the light emitted by the laser into light of the desired color temperatures can be achieved with such a phosphor converter, i.e. a substance that is excited by the light emitted by the laser and as a result emits light with a different spectrum.

In one embodiment, the headlamp includes a first deflection device that is designed for deflecting the light emitted by the first conversion unit and/or the second conversion unit in accordance with a predetermined light distribution. In this way, the highly directional light of the laser can be distributed over the complete area to be illuminated by the headlamp. The deflection device may include, for example, of a microscopic mirror device. In such a microscopic mirror device, the light is deflected by one or more movable mirrors that can be purposefully controlled. In this case, the mirrors are moved by means of small motors or other electromechanical components in order to deflect the light beam in the desired fashion. It would also be conceivable to deflect the light beam by means of rapidly rotating mirrors in accordance with the technology already known, for example, from laser printers.

The predetermined light distribution to be achieved by deflecting the light beam may include, for example, of a high beam light distribution of the motor vehicle. Other especially adapted light distributions can naturally also be realized. For example, the light distribution of the headlamp may also be dynamically adapted to the respective driving situation. It is furthermore possible to adapt the predetermined light distribution to the traffic conditions, the current speed, a cornering maneuver or the like. In this case, the predetermined light distribution may be defined in such a way that the individual regions of the illumination area are respectively illuminated with a certain color temperature of the light emitted by the converter.

In one embodiment, the headlamp includes a second deflection device that is designed for deflecting the light emitted by the laser at the converter in accordance with an additional predetermined light distribution. Consequently, the respective conversion units can be excited in order to emit light with the corresponding color temperature by purposefully deflecting the light emitted by the laser at one of the several conversion units. In this way, the desired color temperature to be emitted can be purposefully selected by activating the corresponding conversion unit with the second deflection device. Analogous to the first deflection device, the second deflection device may also feature one or more electromechanically activated mirrors. However, other alternatives for deflecting the light beam may likewise be considered in this case.

In one embodiment, the first conversion unit and the second conversion unit are arranged in the converter in accordance with a color temperature distribution to be achieved. Since the respective conversion units are arranged in the converter in accordance with the color temperature distribution to be achieved in the illumination area of the headlamp, the corresponding color temperature distribution can already be permanently adjusted in the converter. In this way, a particularly simple specification of the color temperature distribution can be achieved. For example, corresponding phosphor-converting substances may be arranged on the converter in accordance with the color temperature distribution to be achieved.

In one embodiment, the headlamp includes a detector that is designed for detecting the position of an object in the surroundings of the headlamp and for adapting the predetermined light distribution and/or the additional predetermined light distribution based on the detected position of the object. The detector may include, for example, of a camera, an ultrasonic sensor, an infrared sensor or a radar system. The corresponding regions in the illumination area of the headlamp can be adapted based on the detection of objects in the surroundings of the headlamp. For example, the detected object may be illuminated with a different color temperature. Alternatively, such an object may also be illuminated with increased or decreased light intensity. It would likewise be possible to completely exclude the region of a detected object from the illumination area of the headlamp.

In one embodiment, the headlamp includes an optical waveguide that is designed for guiding the light emitted by the laser to a predetermined position. For example, such an optical waveguide may guide the light from the laser to the conversion units of the converter. Alternatively, the optical waveguide may also initially guide the light from the laser to the second deflection device. Since the light is guided from the laser to this predetermined position on the converter or the deflection device, the laser can be arranged in a nearly arbitrary position relative to the remaining components of the headlamp. Consequently, this position can be optimized, in particular, with respect to the space requirement and/or the temperature management. It is therefore not absolutely imperative that the laser is located in the immediate vicinity of the remaining components of the headlamp.

One embodiment of the preferred method the light emitted by the first conversion unit and the second conversion unit is deflected in accordance with a predetermined light distribution. Another embodiment the light emitted by the laser is deflected at the converter in accordance with another predetermined light distribution.

One embodiment includes detecting the position of an object in the surroundings of the headlamp, and adapting the predetermined light distribution and/or the additional predetermined light distribution based on the detected position of the object. In one embodiment, the step for adapting the predetermined light distribution and/or the additional predetermined light distribution changes the color temperature at the detected position of the object. In one embodiment, the step for adapting the predetermined light distribution and/or the additional predetermined light distribution decreases or increases the corresponding light distribution at the detected position of the object.

The present disclosure furthermore includes a device for making available a laser and a device for making available a converter with a first conversion unit and a second conversion unit. The first conversion unit emits light of a first color temperature after its excitation by means of the laser. The second conversion unit emits light of a second color temperature after its excitation by means of the laser. A device for exciting the first conversion unit and the second conversion unit by means of the laser is also provided.

One embodiment furthermore includes a device for deflecting the light emitted by the first conversion unit and the second conversion unit in accordance with a predetermined light distribution.

One embodiment furthermore includes a device for detecting the position of an object in the surroundings of the headlamp and a device for adapting the predetermined light distribution and/or the additional predetermined light distribution based on the detected position of the object. In one embodiment, the device for adapting the predetermined light distribution and/or the additional predetermined light distribution changes the color temperature at the detected position of the object. In another embodiment, the device for adapting the predetermined light distribution and/or the additional predetermined light distribution decreases or increases the corresponding light distribution at the detected position of the object.

The above-described embodiments and enhancements may, if appropriate, be arbitrarily combined with one another. Other potential embodiments, enhancements and implementations of the present disclosure also include combinations of preferred characteristics of the exemplary embodiments described above and below that are not explicitly mentioned. In this respect, a person skilled in the art particularly may also add individual aspects in order to improve or supplement the respective basic design of the present disclosure.

### BRIEF DESCRIPTION OF THE DRAWINGS

The present disclosure will hereinafter be described in conjunction with the following drawing figures, wherein like numerals denote like elements.

FIG. 1 shows a schematic block diagram of a headlamp according to an exemplary embodiment;

FIG. 2 shows a schematic block diagram of a headlamp according to an alternative exemplary embodiment;

FIG. 3 shows a schematic exemplary illumination of a headlamp according to another exemplary embodiment, and

FIG. 4 shows a schematic flow chart, on which another exemplary embodiment of the present disclosure is based.

### DETAILED DESCRIPTION

The attached drawings are intended to further elucidate the embodiments of the present disclosure. These drawings show embodiments and in conjunction with the description serve for explaining principles and concepts of the present disclosure. Other embodiments and many of the above-described advantages result in view of the drawings. The elements of the drawings are not necessarily illustrated true-to-scale. In the drawings, identical, functionally identical and identically acting elements, characteristics and components are—if not indicated otherwise—respectively identified by the same reference symbol.

The following detailed description is merely exemplary in nature and is not intended to limit the present disclosure or the application and uses of the present disclosure. Furthermore, there is no intention to be bound by any theory presented in the preceding background or the following detailed description.

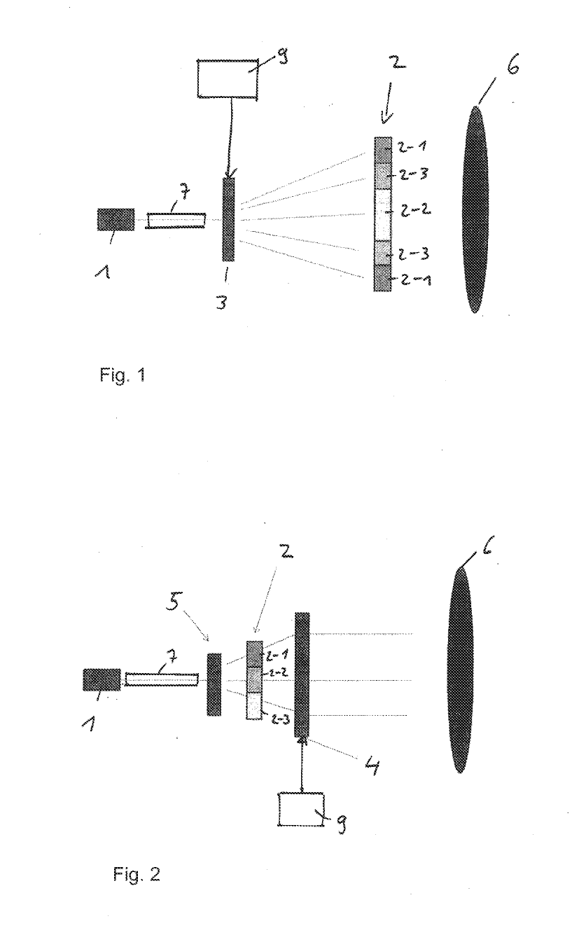

FIG. 1 shows a schematic block diagram of a headlamp 10 according to an exemplary embodiment of the present disclosure. A laser 1 initially generates a laser beam. This laser 1 may include, for example, of a semiconductor laser with a laser diode 1a. However, alternative laser systems may also be used. For example, the laser 1 may likewise include of a gas discharge laser or the like.

In this case, the laser 1 preferably emits monochromatic light with a single predetermined wavelength. This light may lie in the wavelength range between approximately 400 nm and 800 nm that is visible to the human eye. For example, the light emitted by the laser may include of blue light with a wavelength of approximately 450 nm. However, it would alternatively also be possible to use infrared or ultraviolet light that lies outside the wavelength range visible to the human eye.

Subsequently, the light emitted by the laser 1 is initially incident on a deflection device 3. In this case, the light may be directed from the laser 1 directly at the deflection device 3. Alternatively, it is also possible to guide the light to the deflection device 3 by means of a suitable optical waveguide 7.

The deflection device 3 may include, for example, of a microscopic mirror device. Such a microscopic mirror device may include one or more mirrors. These mirrors are respectively moved in a reciprocating fashion by means of suitable control devices. Consequently, the beam path of the light emitted by the laser can be precisely controlled by purposefully activating the individual mirrors. Alternative options for deflecting the light beam emitted by the laser such as, for example, rapidly rotating mirrors or the like may also be considered.

The light of the laser 1 is directed at the converter 2 by the deflection device 3. Depending on the design of the deflection device 3, the converter 2 does not necessarily have to lie in the optical axis of the laser 1, but may also have a different position.

In this case, the converter 2 includes several conversion units 2-1, 2-2, 2-3. Each of these conversion units 2-1, 2-2 and 2-3 includes a substance such as, for example, a phosphor converter that is capable of emitting a light spectrum with a predetermined color temperature after excitation with the light emitted by the laser 1. An adapted arrangement of the individual conversion units 2-1, 2-2 and 2-3 on the converter makes it possible to adapt the light distribution emitted by the converter 2 with respect to the color temperature. For example, the converter 2 may in the edge region feature one or more conversion units 2-2, 2-3 with a phosphor converter that differs from the phosphor converter of the conversion unit 2-1 in the interior of the converter 2. Consequently, the resulting light distribution has a different color temperature in the edge region than in the central region.

One or more lenses 6 may be optionally arranged downstream of the converter 2 and respectively focus or disperse the light emitted by the converter 2 accordingly in order to achieve the desired light distribution in the illumination area of the headlamp.

The headlamp 10 may furthermore include a detector 9 that detects objects in the surroundings of the headlamp 10 and determines their position. The detector 9 may include, for example, of a camera, an infrared sensor, an ultrasonic sensor or a radar system. If the detector 9 detects an object in the surroundings of the headlamp 10, the area illuminated by the headlamp 10 can subsequently be adapted accordingly. For example, the region, in which the object was detected, may only be illuminated with a reduced light intensity or not illuminated at all. For this purpose, the laser beam is deflected by the deflection device 3 in such a way that only a minimal light emission or no light emission at all takes place in the region, in which an object was detected.

FIG. 2 shows a block diagram of an alternative exemplary embodiment of a headlamp 10. Analogous to FIG. 1, light is also emitted by a laser 1 in this exemplary embodiment. The light emitted by the laser 1 is in this case initially incident on a device 5 for deflecting the laser beam at the converter 2. This device 5 for deflecting the laser beam may include, for example, of a rotating mirror that alternately deflects the light at one of the conversion units 2-1, 2-2 or 2-3 of the converter 2.

The converter 2 in this exemplary embodiment also includes two or more conversion units 2-1, 2-2 and 2-3. Each of these conversion units 2-1, 2-2 and 2-3 converts the light arriving from the laser 1 into a light spectrum with a predetermined color temperature. It is likewise preferred that the light emitted by the respective conversion units 2-1 and 2-2 has a different color temperature in this case.

Subsequently, the light emitted by the converter 2 is deflected in accordance with an additional predetermined light distribution by another deflection device 4. In this case, the deflection device 4 may respectively be realized identical or similar to the deflection device 3 in the preceding exemplary embodiment. In this exemplary embodiment, the light may subsequently also be focused or dispersed by means of one or more optical lenses 6.

Analogous to the preceding exemplary embodiment, it is in this exemplary embodiment also possible to detect objects in the surroundings of the headlamp 10 by means of a suitable detection device 9 and to adapt the light distribution.

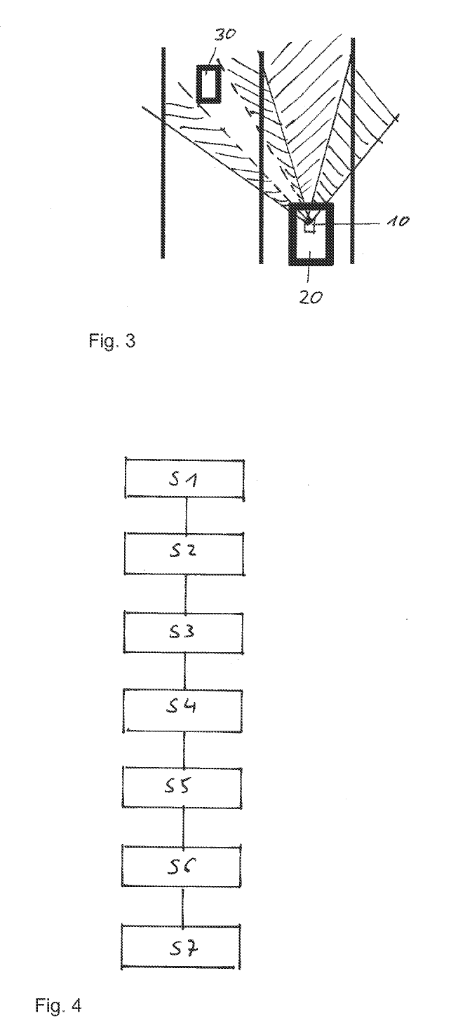

FIG. 3 shows a schematic example of a scene illuminated by a headlamp 10 according to an exemplary embodiment. In this case, the headlamp 10 is arranged in a motor vehicle 20 such as, for example, a passenger car (PKW) or another vehicle. The headlamp 10 preferably includes of a front headlamp of the vehicle. In this case, the headlamp 10 illuminates the roadway in front of the vehicle 20, as well as the edge regions to the left and to the right of the roadway. The deflection device 3 and the additional deflection device 4 are respectively activated in such a way that the central region in front of the motor vehicle is illuminated with light of a first color temperature and the edge region on at least one side is illuminated with light of a different color temperature.

If the detector 9 detects an object 30 in the surroundings of the vehicle 20, particularly of the headlamp 10, the corresponding illumination area can be changed at the position of the detected object 30. For example, such a detected object 30 may be illuminated with light of a different color temperature. It is furthermore possible to illuminate the detected object 30 with a higher or lower light intensity or to completely exclude the object 30 from the illumination area. For example, the deflection device 3 or 4 may suitably deflect the light for this purpose.

FIG. 4 shows a schematic flow chart, on which another exemplary embodiment of the present disclosure is based. A laser 1 is provided in step S1. A converter 2 is provided in step S2. The converter includes a first conversion unit 2-2 and at least one second conversion unit 2-1, 2-3. After its excitation by means of the laser 1, the first conversion unit 2-2 emits light of a first color temperature. The second conversion unit 2-1, 2-3 emits light of a second color temperature after its excitation by means of the laser. In step S3, the first conversion unit 2-2 and the second conversion unit 2-1, 2-3 are excited by means of the laser.

In step S4, the light emitted by the first conversion unit 2-2 and the second conversion unit 2-1, 2-3 can furthermore be deflected in accordance with a predetermined light distribution. The light emitted by the laser 1 may additionally or alternatively also be deflected at the converter 2 in accordance with an additional predetermined light distribution in step S5.

In an optional step S6, it is furthermore possible to detect the position of an object in the surroundings of the headlamp 10 and to subsequently adapt the predetermined light distributions based on the detected position of the object in step S5. In step S7 for adapting the predetermined light distributions, the light distributions can be changed in such a way that light of a different color temperature is emitted at the positions of the objects. In step S7 for adapting the predetermined light distributions, the intensity of the light may additionally or alternatively also be decreased or increased at the detected position of the object.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-15. (canceled)

17. A headlamp for a vehicle comprising:
a laser; and
a converter having a first conversion unit configured to emit light of a first color temperature after excitation by means of the laser and a second conversion unit configured to emit light of a second color temperature after excitation by means of the laser.

18. The headlamp according to claim 17, wherein the laser includes a laser diode.

19. The headlamp according to claim 17, wherein the first color temperature and the second color temperature are different.

20. The headlamp according to claim 17, wherein at least one of the first conversion unit and the second conversion unit comprise a phosphor converter.

21. The headlamp according to claim 17 further comprising a first deflection device configured to deflect the light emitted by at least one of the first conversion unit and the second conversion unit in accordance with a predetermined light distribution.

22. The headlamp according to claim 21 further comprising a second deflection device that is designed for deflecting light emitted by the laser at the converter in accordance with an additional predetermined light distribution.

23. The headlamp according to claim 22, wherein the first conversion unit and the second conversion unit are arranged in the converter in accordance with a color temperature distribution to be achieved.

24. The headlamp according to claim 21 further comprising a detector that configured to detect a position of an object in an area surrounding the headlamp and to adapt the predetermined light distribution based on the detected position of the object.

25. The headlamp according to claim 17 further comprising an optical waveguide configured to guide light emitted by the laser to a predetermined position.

26. A motor vehicle with a headlamp according to one of claim 17.

27. A method for operating a headlamp for a vehicle comprising:
providing a laser;
providing a converter having a first conversion unit and a second conversion unit;
exciting the first and second conversion units by means of the laser such that the first conversion unit emits light of a first color temperature, and the second conversion unit emits light of a second color temperature.

28. The method according to claim 27, further comprising deflecting the light emitted by at least one of the first conversion unit and the second conversion unit in accordance with a predetermined light distribution.

29. The method according to claim 27 further comprising deflecting the light emitted by the laser at the converter in accordance with an additional predetermined light distribution.

30. The method according to claim 28 further comprising detecting the position of an object in a surrounding of the headlamp, and adapting the predetermined light distribution based on the detected position of the object.

31. The method according to claim 27, wherein adapting the predetermined light distribution changes the color temperature at the detected position of the object.

32. A non-transitory computer-readable medium containing a computer program configured to make a computer executed a method for operating a headlamp for a vehicle of the type having a laser and a converter including a first conversion unit and a second conversion unit, the method according to claim 27.
